(19) United States
(12) Patent Application Publication
(10) Pub. No.: US 2005/0129494 A1
(43) Pub. Date: Jun. 16, 2005

(54) Adjustable forklift adapter and method

(76) Inventors: Billy G. Chandler, Texarkana, AR (US); Odis D. Hyman, Fouke, AR (US)

Correspondence Address: LITMAN LAW OFFICES, LTD, PO BOX 15035, CRYSTAL CITY STATION, ARLINGTON, VA, 22215, US

(21) Appl. No.: 10/732,460

(22) Filed: Dec. 11, 2003

(51) Int. Cl. B66F 1/00

(52) U.S. Cl. 414/607

(57) ABSTRACT

The forklift adapter includes a tine portion extending generally horizontally forwardly from a proximal end, a leg portion extending generally vertically along a vertical axis from the said proximal end of the tine portion, and a top portion extending generally rearward from near the top of the leg potion. The leg portion includes an upper leg member and a lower leg member which are slidingly engaged to one another such that the leg portion is extensible. Also provided is a means for locking the upper leg member to the lower leg member into a selected fixed position with respect to one another. A hydraulic implement may be adapted to lift paletted and other loads by hanging two such forklift adapters over the implement.

### BACKGROUND OF THE INVENTION

1. Field of the Invention

The present invention relates to forklifts. In particular, the present invention relates to an adapter to convert, and a method to adapt, a wide variety of existing earth moving and farming implements and attachments, hereinafter “hydraulic implements,” to lift paletted loads and other cargo.

2. Description of the Related Art

There have been a number of attempts at providing forklift adapters to existing hydraulic equipment, with varying degrees of success.

U.S. patent application Publication 2003/0068217, published Apr. 10, 2003, shows a fork attachment for a backhoe but requires either removal of the bucket from the backhoe arm, or the modification thereof with adapter plates.

U.S. Pat. No. 6,524,054, issued on Feb. 25, 2003 to F. Maney, discloses a forklift apparatus having a tongue which is matable to the square tow hitch receiver mounted to the rear end of an automobile or light truck. The forklift apparatus described by Maney includes a pair of tines laterally and adjustably fixed to a crossbar member that is connected to a jack. The tines are not attachable to different types of hydraulic implements such as loaders, buckets or blades.

U.S. Pat. No. 6,547,508 issued Apr. 15, 2003 and U.S. Pat. No. 6,287,070 issued Sep. 11, 2001 to J. A. Perry, disclose a load bearing attachment for a multipurpose loader bucket. This device latches onto the lower horizontally extending lip of the bucket and is not adaptable or configurable for use with different types of hydraulic implements.

U.S. Pat. No. 6,287,073, issued Sep. 11, 2001 and U.S. Pat. No. 6,533,526, issued Mar. 18, 2003 to G. Lindgren et al., disclose a detachable forklift frame having a pair of laterally adjustable load-carrying forks or tines. The tines are supported by a rack fixed to the frame, but are not adjustable for use with various other hydraulic implements.

U.S. Pat. No. 3,876,090, issued Apr. 8, 1975 to J. D. Holland, and U.S. Pat. No. 6,065,926 issued May 23, 2000 to D. G. Knapp, show a forklift configured for attachment to a farm tractor's three-point hitch. Use of these devices requires that whatever implement currently attached to the tractor be removed prior to attaching the forklift attachment. With regard to the Knapp device, the tines are laterally adjustable by sliding along a support beam. However, they are not adjustable in other directions nor are they suitable for use with an existing hydraulic implement.

U.S. Pat. No. 4,421,449, issued Dec. 20, 1983 to V. Cotton, and U.S. Pat. No. 5,582,502, issued Dec. 10, 1996 to L. L. Herin, show forklift attachments designed to be mounted to a snowblade lift. As with other prior art devices, however, the snowblade must first be removed prior to attaching the forklift attachment. With regard to the Cotton device, the tines are slidably mounted to a cross-frame member. However, they are not adjustable, nor are they suitable for use with an existing hydraulic implement.

As can be seen, the prior art forklift adapters are variously heavy, unwieldy, expensive, and complex. None are easily carried or stored when not in use and none are adequately adaptable for use with a variety of existing hydraulic implements.

None of the above inventions and patents, taken either singly or in combination, is seen to describe the instant invention as claimed. Thus, an adjustable forklift adapter solving the aforementioned problems is desired.

### SUMMARY OF THE INVENTION

The forklift adapter of the present invention includes a tine portion extending generally horizontally forwardly from a proximal end, a leg portion extending generally vertically along a vertical axis from the said proximal end of the tine portion, and a top portion extending generally rearward from near the top of the leg potion. The leg portion includes an upper leg member and a lower leg member which are slidingly engaged to one another such that the leg portion is extensible. Also provided is a means for locking the upper leg member to the lower leg member into a selected fixed position with respect to one another. A hydraulic implement may therefore be adapted to lift paletted and other loads by hanging two such forklift adapters over the implement.

Accordingly, it is a principal object of the invention to provide an adapter to enable existing hydraulic implements to be used for lifting paletted loads without modifying existing equipment or removing any attachments or implements.

It is another object of the invention to provide an adapter that allows existing equipment to be used for lifting paletted loads that is easy to install and remove.

It is a further object of the invention to provide such an adapter that is easy to carry by a single person from place to place and to store.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of an exemplary adjustable forklift adapter according to the present invention.

FIG. 2 is a section view taken along lines 2-2 of FIG. 1.

FIG. 2A is a detail cross-section view of the adjustable forklift adapter of FIG. 2, where the cross section is taken along line 2A-2A.

FIG. 3 shows a loader implement fitted with two of the adjustable forklift adapters shown in FIGS. 1 and 2.

FIG. 4 shows a pair of the adjustable forklift adapter of FIGS. 1 and 2 used with a box blade.

Similar reference characters denote corresponding features consistently throughout the attached drawings.

### DETAILED DESCRIPTION OF THE PREFERRED EMBODIMENT

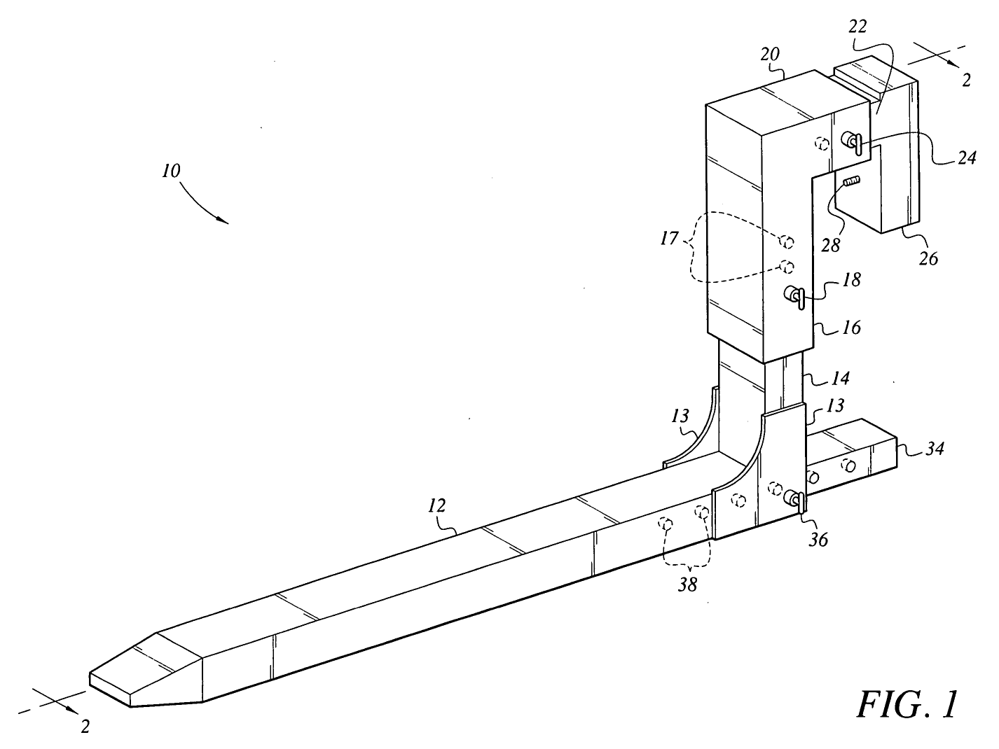

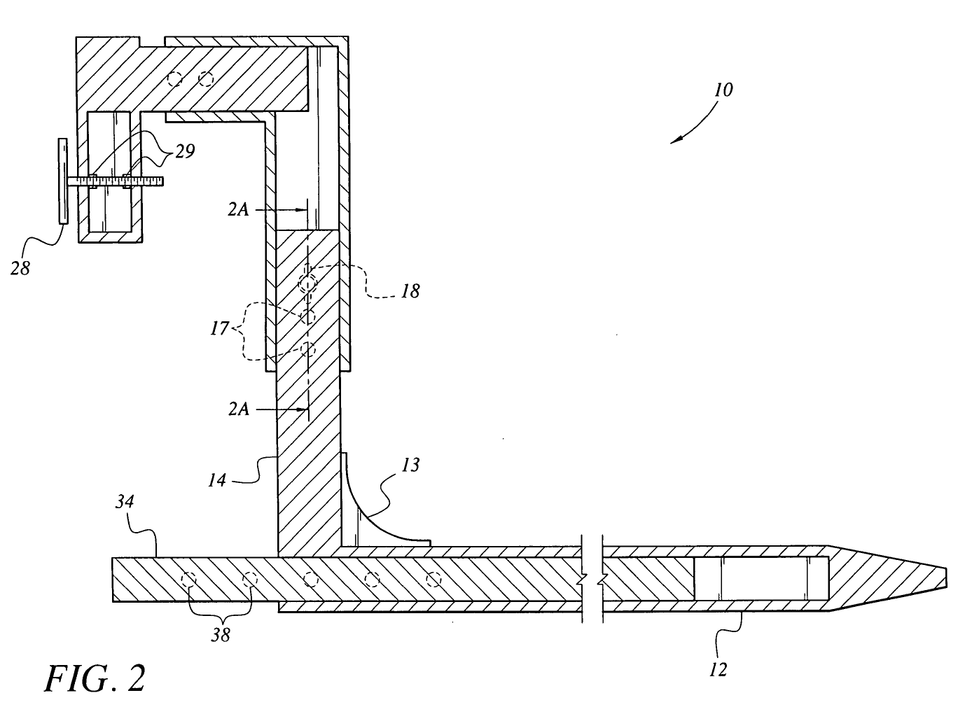

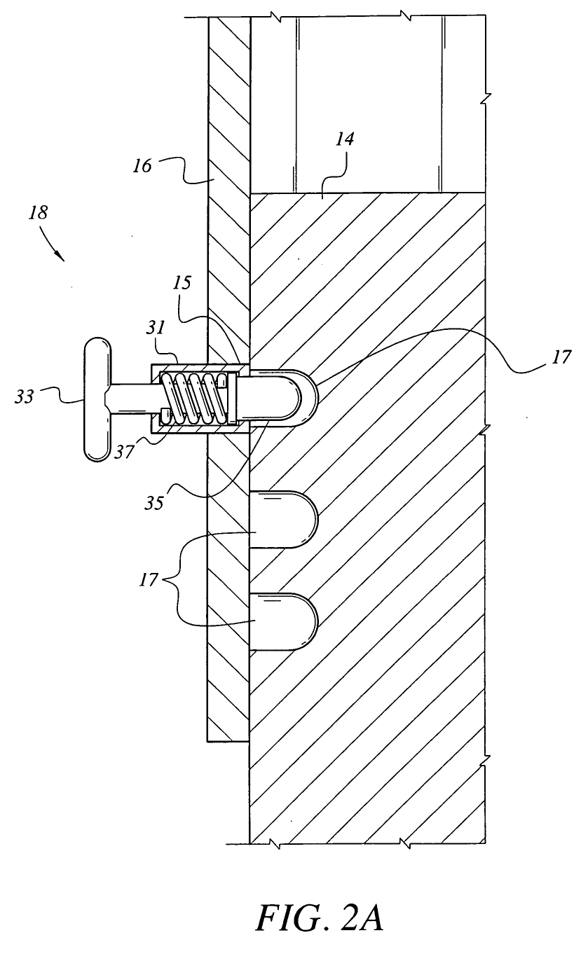

Referring to FIG. 1, an adjustable forklift adapter is shown generally at 10. Forklift adapter 10 includes a tine 12 extending horizontally and useful for lifting loads such as are commonly placed on a pallet or skid. Tine 12 is fixed to lower leg member 14, which extends substantially vertically from the proximal end of tine 12. Side braces 13 strengthen the connection between tine 12 and lower leg member 14. Lower leg member 14 slidingly engages upper leg member 16. As shown in FIG. 2, lower leg member is a solid post slidingly engaged with upper leg member 16, which is formed from rectangular steel tubing.

A spring-loaded pop pin 18 locks lower leg member 14 to upper leg member 16. Spring-loaded pop pins are known to the field of exercise equipment. Referring now to FIG. 2A, spring-loaded pop pins generally include a cylindrical housing 31 containing an internal pin 35 biased to extend out of housing 31 in a first direction (into blind hole 17) by compression spring 37. Handle 33, which is fixed to internal pin 35, extends out of housing 31 opposite the first direction so that internal pin 35 can be retracted into housing 31 by pulling on handle 33. Spring-loaded pop pins of the type contemplated for the present adjustable forklift adapter are available from Innovative Components, Inc. in Schaumburg, Ill., USA. Additional details of the construction of the spring-loaded pop pin can be obtained from U.S. Pat. No. 4,239,412, issued Dec. 16, 1980 to Hogan, which is hereby incorporated by reference.

In a preferred construction, spring-loaded pop pin 18 is welded to an opening 15 in upper leg member 16 to allow internal pin 35 to extend into blind holes 17 drilled into lower leg member 14. While only three blind holes 17 are shown in FIGS. 1, 2, and 2A, any number of holes may be provided, each preferably about one inch to one and one-half inch (2.5-3.8 cm) deep and at about one-inch (2.5 cm) intervals along a length of lower leg member 14. When adjustment is desired, the user pulls handle 33 extending out of spring-loaded pop pin 18 to retract internal pin 35 from one of holes 17, thereby releasing the connection between upper and lower leg members 16, 14 and allowing lower leg member 14 to freely extend from or retract into upper leg member 16. When a desired amount of extension is reached, the user releases spring-loaded pop pin 18 and when a hole 17 is aligned therewith, the internal pin will automatically engage under the influence of internal compression spring 37.

Upper leg member 16 is fixed at or near its upper end to first top member 20, which slidingly engages second top member 22. Spring-loaded pop pin 24 locks first top member 20 with second top member 22 in the same manner that spring-loaded pop pin 18 locks upper and lower leg members 16, 14, as described above with reference to FIG. 2A. Second top member 22 includes a downwardly extending rear portion 26.

Referring back to FIGS. 1, 2, T-handle bolt 28, shown in FIG. 2, is provided to engage or clamp onto the lip of whatever implement or attachment forklift adapter 10 is used with. T-handle bolt is threaded to nuts 29 welded to rear portion 26. It is also contemplated that rear portion 26 may include directly threaded holes or a threaded bushing.

While lower leg member 14 and upper leg member 16 are slidingly engaged by a post-in-tube configuration, this is not the only method contemplated of slidingly engaging the two leg members together. For example, the members may be formed of channel-in-channel, nested angle iron with pin-in-slot cooperating elements, or other cooperating shapes. Preferably, the members are formed by a solid rectangular post extensible within a rectangular tube having outside dimensions of about 2 inches (5 cm) by 4 inches (10 cm).

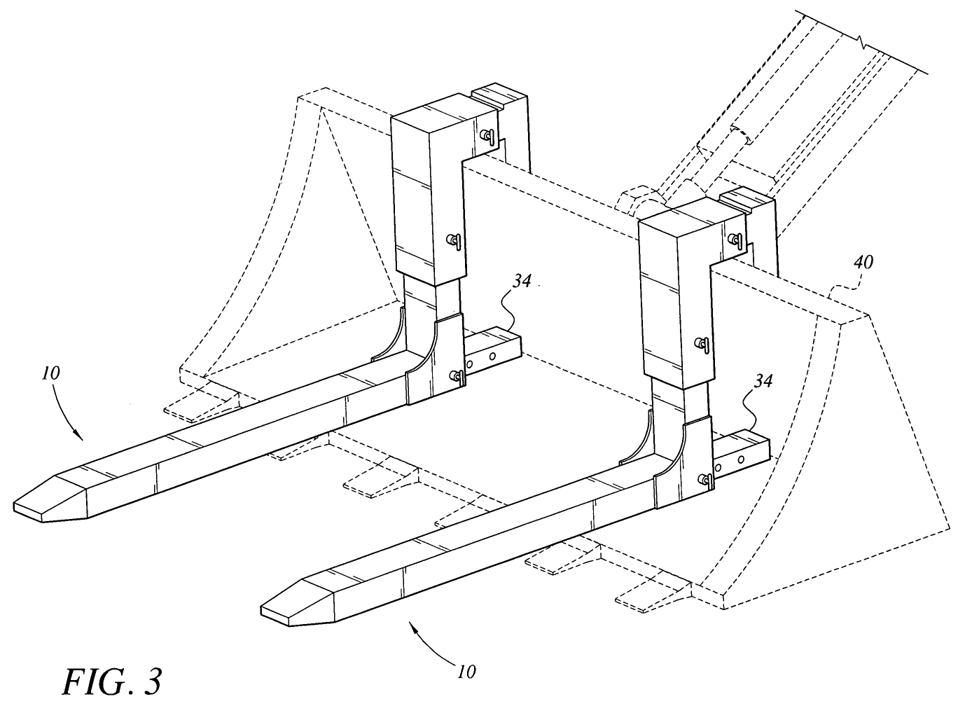

Extensible rear brace 34 is slidingly engaged to tine 12 and extends rearward of tine 12 in case additional bracing is-required. Spring-loaded pop pin 36, positioned at one of side braces 13, locks rear brace 34 in any desirable position. Rear brace 34 is useful in situations where tines 12 would otherwise point down. For example, if a forward-sloping dirt or snow blade is used, rear brace 34 may be extended to push against the vertical back part of the blade to maintain tine 12 in a horizontal position. In other cases, a bucket, loader, or other similar implement may lack a vertical support to prevent tine 12 from slanting down. The advantages of rear brace 34 in these circumstances will be further described below with reference to FIG. 3.

Preferably, locking means locking upper leg member 16 to lower leg member 14, first upper portion 20 to second upper portion 22, and tine 12 to rear brace 34 is provided by spring-loaded pop pins 18, and 24, and 36, as shown and described above with respect to FIG. 2A. However, other locking means are contemplated. For example, a pin may extend through both members and retained using a cotter- or hair-pin (not shown) extending through the pin's terminus. Or a threaded bolt and nut combination may be used to lock two members together. Alternatively, instead of a device for locking at discrete positions, a self-locking jackscrew or other continuously adjustable mechanism may be used to adjust the length of leg members 14, 16 and other slidingly engaged parts.

Furthermore, while the leg portion is shown as comprising lower leg 14 and upper leg 16 only, it is also possible to include a third intermediate leg portion (not shown) to provide increased extension capability. The same holds true for the top portion.

Tine 12 preferably has a length of about 3.5 feet (1 m). Upper leg 16 and lower leg 14 preferably have a combined length when collapsed of about 18 inches (46 cm). First and second top members preferably have a combined length when collapsed of about 6 inches (15 cm). Rear portion 26 has a preferred length of about 4 to 6 inches (10-15 cm) from the top of adapter 10. These dimensions are considered to be the most desirable so that forklift adapter 10 can cooperate with the largest number of existing implements and attachments. However, many other possible dimensions are possible without departing from the spirit and scope of the invention. For example, the vertically extending leg members, the top members, and/or rear member may be elongated with respect to other portions of the adapter, or the entire adapter may be scaled up or down to suit various needs.

Referring now to FIG. 3, a pair of forklift adapters 10 are shown hooked onto a typical loader implement 40 of, for example, a bulldozer (not shown). Note that adapters 10 may be adjusted so that tines 10 are positioned even with the bottom edge of dirt blade 40. Top members hook over the top of dirt blade 30 while rear braces 34 are used to provide additional stability to adapters 10 by bracing against the inside wall of loader blade 40. Adapters 10 may be laterally adjusted by sliding them left or right along the width of dirt blade 40. This might be necessary for example, in moving large objects such as garbage dumpsters. If desired, more than two forklift adapters may be used to, if needed, stably lift heavier or wider loads, such as a shed or other portable structure.

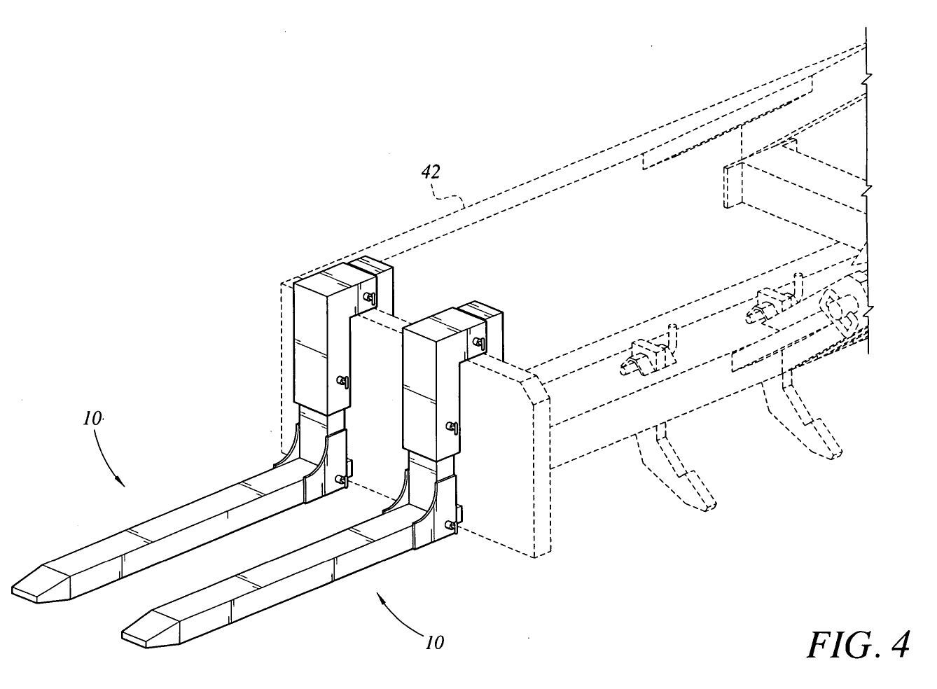

Referring to FIG. 4, two forklift adapters 10 are shown hooked on the outer side of a box blade 42 of loading/grading equipment (not shown).

It is to be understood that the present invention is not limited to the embodiment described above, but encompasses any and all embodiments within the scope of the following claims.

1. A forklift adapter, comprising:
a tine portion having a proximal end and a distal end, the tine portion extending generally horizontally forwardly from the proximal end to the distal end;
a leg portion extending generally vertically along a vertical axis from the proximal end of said tine portion, the leg,portion having:
an upper leg member;
a lower leg member slidably engaged with the upper leg member so that the leg portion is extensible along the vertical axis; and
locking means for locking the upper leg member and the lower leg member into a fixed position relative to each other; and
a top portion extending generally horizontally rearward from said leg potion, said top portion, said leg portion, and said tine portion all being substantially coplanar.

2. A pair of forklift adapters according to claim 1, the top portions of the forklift adapters being adapted for hooking onto a hydraulically operated blade of a piece of heavy equipment in order to lift a paletted load.

3. The forklift adapter of claim 1, wherein said leg portion and said top portion are formed from tubular steel, said upper leg member being coaxial with said lower leg member, one of said upper and lower leg member being slidingly received within another of said upper and lower leg member.

4. The forklift adapter of claim 3, wherein said tubular steel has a rectangular cross section of about 2 inches (5 cm) by about 4 inches (10 cm).

5. The forklift adapter of claim 3, wherein said lower leg member is received in said upper leg member.

6. The forklift adapter of claim 1, wherein said top portion comprises:
a first top member fixed to said leg portion and extending rearward from said leg portion;
a second top member slidingly engaged to said first top member so that said top portion is extensible; and
top locking means for fixing said first top member to said second top member into a selected fixed position with respect to one another.

7. The forklift adapter of claim 6, wherein said top portion further comprises a rear portion depending from a proximal end of said top portion, said rear portion extending substantially parallel to said leg portion.

8. The forklift adapter of claim 7, further comprising a spring-loaded pin extending forward of said rear portion at a lower end thereof.

9. The forklift adapter of claim 6, wherein said leg portion and said top portion are formed of tubular steel and said first top member coaxially receives said second top member.

10. The forklift adapter of claim 9, wherein said tubular steel has a rectangular cross section.

11. The forklift adapter of claim 1, wherein said locking means comprise a spring-loaded pop pin.

12. A forklift adapter, comprising:
a tine portion having a proximal end and a distal end, the tine portion extending generally horizontally forwardly from the proximal end to the distal end;
a leg portion extending generally vertically along a vertical axis from the proximal end of said tine portion; and
a top portion extending generally horizontally rearward from said leg potion, said top portion having:
a first top member fixed to said leg portion and extending rearward from said leg portion;
a second top member slidingly engaged to said first top member so that said top portion is extensible; and
locking means for fixing said first top member to said second top member into a selected fixed position with respect to one another.

13. A pair of forklift adapters according to claim 12, of claim 12, the top portions of the forklift adapters being adapted for hooking onto a hydraulically operated blade of a piece of heavy equipment in order to lift a paletted load.

14. The forklift adapter of claim 12, wherein said leg portion and said top portion are formed from tubular steel, said first top member being coaxial with said second top member, one of said first and second top members being slidingly received within another of said first and second top members.

15. The forklift adapter of claim 14, wherein said tubular steel has a rectangular cross section of about 2 inches (5 cm) by about 4 inches (10 cm).

16. The forklift adapter of claim 14, wherein said second top member is received in said first top member.

17. The forklift adapter of claim 12, wherein said locking means comprise a spring-loaded pop pin.

18. A method of adapting a hydraulic implement to lift paletted loads, the method comprising the steps of:
hanging two forklift adapters over an upper edge of said implement, each forklift adapter including no more than one tine portion, an extensible leg portion extending up from a rear, proximal end of said tine portion, and a top portion extending rearward of an upper end of said leg portion, said hanging step further including the steps of:
positioning each said forklift adapter in laterally-spaced relation to one another;
extending said leg portion so that it extends from said upper edge of said implement to a lower edge of said implement; and
locking said leg portion to prevent it from extending or contracting after said extending step.

19. The method of claim 18, wherein said top portion is extensible and said method further comprises the steps of:
adjusting a length of said top portion so that it grips said upper edge; and
locking said top portion in order to prevent it from extending or contracting after said adjusting.

20. The method of claim 18, said hanging step further comprising the steps of:
retracting a spring-loaded pin extending forward of a rear portion that depends from a rear end of said top portion,
lowering said top portion over said upper edge, and
releasing said spring loaded pin. 19
